(19) United States
(12) Patent Application Publication
(10) Pub. No.: US 2008/0067007 A1
(43) Pub. Date: Mar. 20, 2008

(54) BELT FOR AN ELEVATOR SYSTEM AND METHOD OF MANUFACTURING SUCH A BELT

(76) Inventor: Ernst Ach, Ebikon (CH)

Correspondence Address: FRASER CLEMENS MARTIN & MILLER LLC, 28366 KENSINGTON LANE, PERRYSBURG, OH, 43551, US

(21) Appl. No.: 11/836,407

(22) Filed: Aug. 9, 2007

Related U.S. Application Data
(60) Provisional application No. 60/822,123, filed on Aug. 11, 2006.

(30) Foreign Application Priority Data
Aug. 11, 2006 (EP) 06118816.5

(51) Int. Cl. B66B 7/00; B29D 29/00

(52) U.S. Cl. 187/250; 474/238

(57) ABSTRACT

A method of manufacturing a belt for an elevator system includes the steps of: manufacturing a first belt part that has an arrangement of grooves, in particular in the lengthwise direction of the belt; arrangement of a tension bearer in at least one of the grooves; and connection of a second belt part with the first belt part whereby the tension bearer is accommodated in the interior of the belt.

### CROSS-REFERENCE TO RELATED APPLICATION

This application claims the benefit of U.S. provisional patent application Ser. No. 60/822,123 filed Aug. 11, 2006.

### FIELD OF THE INVENTION

The present invention relates to an elevator system with a belt, a belt for such an elevator system, and a method of manufacturing such a belt.

### BACKGROUND OF THE INVENTION

An elevator system comprises an elevator car and usually a counterweight that can be moved in an elevator hoistway or along freestanding guide devices. To impart the movement, the elevator system has at least one drive with at least one drive sheave respectively that via one or more belts bears the elevator car and the counterweight and/or transfers to them the necessary traction forces. In a manner that is in itself known, the drive sheave can be embodied as a traction sheave or equally as a sheave of smaller diameter, in particular also as a drive shaft of the drive itself.

The elevator car and the counterweight can be connected via the same belt or belts that is/are diverted over the drive sheave or drive sheaves. Alternatively, the elevator car and counterweight respectively can be connected via separate belts to the drive sheave or drive sheaves in such manner that the counterweight rises when the elevator car is lowered and vice versa. Whereas drive sheaves exercise tension forces on the traction belts to raise the elevator car or counterweight, pure suspension belts are not diverted over drive sheaves but only over diverting elements, in particular swiveling or fixed diverting pulleys, and take up a constant part of the weight force of the elevator car and of the counterweight. With regard to preference, however, traction and suspension belts are identical.

A belt according to the present invention can be used for each of the functions described above, in other words equally as a drive and/or suspension belt, as one of several belts, and/or as a belt that is fastened to the elevator car and/or the counterweight. Drive sheaves and diverting pulleys are accordingly hereafter referred to generically as “belt sheaves”.

Such belts for elevator systems usually contain a belt body of elastomers. To transmit the tension forces, tension bearers in the form of steel and/or plastic cords are embedded in the belt body that are preferably constructed of singly or multiply laid wires or plastic fibers or plastic yarns. Advantageously, they are arranged in the neutral fiber of the belt cross section in which no tensile or compressive stresses arise on wrapping of a belt sheave.

For the purpose of arranging the tension bearers in correct position in the belt during manufacture, it is known, for example, from patent publication WO 2006/000500 A1 for the tension bearers that are present in the form of steel and/or plastic cords to be fed to a first molded sheave onto which a plasticizable plastic, in particular PU, is simultaneously applied from an extruder. The molded sheave has a circumferential surface with cross ribs that are arranged in the form of an arrow. As a result of the tension in the wire, the tension bearers are pressed onto the head surfaces of the cross ribs. Extrusion of the plasticizable plastic creates a first belt part that has on its underside grooves that are formed by the arrowlike cross ribs of the molded sheave in whose area the tension bearers freely lie. This belt part is guided to a second molded sheave, there being again applied between the second molded sheave and the underside of the first belt part from an extruder a plasticizable plastic, in particular PU, that fills the grooves of the first belt part, embraces the tension bearers in doing so, and forms a second belt part that is thermically tightly bonded to the underside of the first belt part. The belt is thereby formed in two parts from two belt parts of the same material, the tension bearers being arranged in the contact plane of both belt parts in which the two belt parts are connected to each other by positive fit as well as material bonding.

This method of manufacture and the elevator belts that are manufactured according to this method have several disadvantages.

The position of the individual tension bearers within the belt is defined by a feeding device that guides the tension bearers before they run onto the first molded sheave. During the extrusion process, i.e. while the tension bearers are passing over the first molded sheave, the lateral guidance of the tension bearers takes place only by the frictional engagement that is exerted on the first molded sheave by the cords that comprise the tension bearers. This requires on the one hand a substantial tension in the wires of the tension bearers to generate the normal force that is needed to generate the frictional engagement. This has the consequence that the tension bearers cannot be enclosed in the belt without tension. However, even if the tension in the wires is high, an exact lateral position of the tension bearers within the belt cannot be guaranteed.

Although the construction from two belt parts of identical material is advantageous for the formation of a permanent connection, it requires the belt to conduct tension forces into the belt not only on its traction surface with which it interacts by frictional engagement and positive fit with a drive sheave, but also to have the same coefficient of friction on the reverse side of the belt that faces away from the traction surface with which it surrounds the diverting elements. Since the traction surface for increasing the tractive and driving capacity of the belt generally has a high coefficient of friction, the friction on the reverse side of the belt increases disadvantageously on diversion of the belt with the result that, for example, the lateral guidance of the belt on a diverting pulley is hindered.

### SUMMARY OF THE INVENTION

An objective of the present invention is therefore to propose a method of manufacturing a generic belt for an elevator installation in which the correct positional arrangement of tension bearers in the belt is reliably realized. A further objective of the present invention is to make available a generic belt for an elevator installation in which the load on diversion is reduced.

In fulfillment of the objective, a method of manufacturing a belt for an elevator system is proposed.

A method according to the present invention for manufacturing a belt for an elevator system comprises the following steps: Manufacturing of a first belt part that has an arrangement of one or more grooves in the lengthwise direction of the belt, arrangement of a tension bearer in at least one groove of the arrangement, and connection of a second belt part with the first belt part in such manner that at least one tension bearer is accommodated in the interior of the belt.

Through the arrangement of the tension bearers in grooves of the first belt part, a positionally correct arrangement of the tension bearers during the manufacturing process can be assured with simple means. This is because the tension bearers are guided by positive engagement through the grooves crosswise to the belt so that their correct positional arrangement relative to each other and to the rest of the belt can be predetermined by the geometry of the grooves, particularly of their width and distance from each other.

It is preferable for one tension bearer to be arranged in each groove. It is, however, equally possible for a plurality of tension bearers to be arranged in the same groove whereby at least the positionally correct arrangement of these tension bearers to further tension bearer arrangements in other grooves is predetermined. Conversely, it is not necessary for there to be a tension bearer arranged in every groove of the first belt part. Thus it is possible, for example, for a generic first belt part to be fitted with a different number of tension bearers so that from a semi-finished product a plurality of different belts with various tensile strengths can be manufactured.

In addition to the grooves for accommodating tension bearers, the first belt part can also have further openings and/or projections that interact by positive fit with corresponding projections and openings in the second belt part and thus reinforce the bonding between the two belt parts.

The tension bearers can be embedded in the grooves of the first belt parts without pretension. In particular it is thereby possible to manufacture low-stress belts. Whereas with the manufacturing method that is known from patent publication WO 2006/000500 A1 such tension bearers cannot be reliably fixed in the desired position on the molded sheave and thereby within the belt, the grooves according to the present invention bring about a reliable determination of the position of the tension bearers across the width of the belt.

It is preferable for the tension bearers to be inserted into the grooves of the first belt part before the second belt part is connected to the latter and thereby completely encloses the tension bearers within the belt. The tension bearers can, however, equally well be first arranged on the second belt part. Through connection with the first belt part, the latter, on account of its grooves, pulls the tension bearers, if necessary only slightly and by release of a previously applied pretension in the tension bearers, into their final position.

It is preferable for the first belt part to be manufactured from a thermoplastic plastic. This may be, for example, polyamide (PA), polypropylene (PP), polyethylene (PE), polycarbonate (PC), or polyvinyl chloride (PVC). The thermoplastic plastic can also with advantage be a polyblend, i.e. a mixture of two or more different plastics. The first belt part can also contain a fabric of one of these thermoplastic plastics that can preferably be embedded in, or impregnated with, a further one of these thermoplastic plastics.

This first, preferably rather hard, belt part guides the individual tension bearers reliably in its grooves. In a further embodiment of the manufacturing method according to the present invention, after the first belt part has been joined to the second belt part the former can be (partially) re-plasticized by heating so that the tension bearers that are then also partially surrounded by the second belt part and thereby fixed in their positional arrangement relative to each other engage better in the grooves of the first belt part that are to this extent partially deformable.

The grooves of a belt according to the present invention can also be formed by thermal and/or mechanical deformation of the first belt part. They can thus be formed already during molding of the first belt part and/or subsequently by machining or deformation under renewed heating of the first belt part, thus for example by milling, hot pressing, rolling, or similar.

The grooves of a belt according to the present invention are preferably embodied V-shaped or U-shaped. This advantageously centers the individual tension bearers, that usually have a rotationally symmetrical, in particular essentially round, cross section, in the bottom closed end of the grooves. It is advantageous for tension bearers of different diameter to be arranged in the same first belt part, the tension bearers entering into the V- or U-shaped grooves at different depths depending on their diameter. In another variant, the grooves can also essentially match the (partial) external contour of the tension bearers. It is advantageous for the grooves to be formed in such manner that the tension bearers arranged within them are arranged in or near the neutral fiber of the cross section of the entire belt in which, on wrapping of a belt sheave, in particular a drive sheave, no or only low tensile or compressive stresses occur.

It is advantageous for the grooves of a belt according to the present invention to be so formed that the tension bearers are not arranged in their entire height within the grooves but project beyond the latter into the second belt part. In this manner the traction surface between the tension bearers and the second belt part enlarges, which is particularly advantageous if this is provided to engage with a drive sheave of the elevator system, so that the tension forces are transferred from the drive sheave via the second belt part onto the tension bearers. To this extent it is preferable for the grooves to be so flat that they ensure a positionally correct arrangement of the tension bearers, in which the tension bearers project as far as possible into the second belt part.

The tension bearers can be embodied as a single wire or consist of singly or multiply laid strands or ropes, it being possible for the latter to be manufactured from steel wires or plastic fibers. Laid tension bearers can additionally contain cores, in particular of plastic. As a result of the certain positioning of the individual tension bearers in the grooves during the manufacturing process, in addition to low-twist ropes, ropes can also be used that as a result of the lay, for example, tend to twist crosswise to the belt.

It is preferable for the second belt part to be manufactured from an elastomer, for example polyurethane, polychloroprene, and/or ethylene propylene diene rubber. A belt is thereby advantageously created that has different materials on its two sides that can be respectively adapted to the different requirements. A material can thus be selected for the first belt part that ensures stable guidance of the tension bearers in the grooves and also has adequate flexibility when as an outside curve segment it is diverted over a belt sheave. For the second belt part a material can be selected that is particularly suitable for transmission of the tensile forces from the drive sheave onto the tension bearers. Here in particular, a material is to be preferred that develops adequate adhesion relative to the tension bearers, has a desired tractive capacity with a drive sheave, and at the same time tolerates the tensions and deformations that occur on the transmission of force. For this purpose especially suitable have proven to be elastomers with a hardness of 70 to 100 Shore (A), preferably 75 to 95 Shore (A), and particularly preferable a hardness of 80 to 85 Shore (A).

It is advantageous for the second belt part to be fastened to the first belt part by means of extrusion and/or adhesive bonding. If the second belt part is extruded onto the first, a particularly simple manufacturing process results. At the same time, first and second belt parts join firmly and permanently. It is advantageous for the second belt part on extrusion to surround the tension bearers over the entire area of its circumferential surfaces that does not rest in the grooves of the first belt part, which reinforces the connection between the first and second belt parts and the tension bearers.

In like manner, the second belt part can be pre-made as a semi-finished product and adhesive bonded to the first belt part. The pre-made second belt part preferably has openings that are essentially complementary to the tension bearers that are arranged in the grooves. Preferably, these openings can be somewhat smaller than the tension bearers so that on joining the two belt parts the tension bearers are tightly held between them under deformation of the second belt part.

In a preferred embodiment of the present invention, arranged on the side of the first belt part that faces away from the second belt part is a third belt part that is preferably manufactured from a thermoplastic plastic such as, for example, polyamide (PA), polypropylene (PP), polyethylene (PE), polycarbonate (PC), or polyvinyl chloride (PVC). This thermoplastic plastic can also be a polyblend, i.e. a mixture of two or more different plastics. The third belt part can also contain a fabric made of one of these thermoplastic plastics.

Such a three-part construction makes it possible to use for the respective function of the individual belt parts other optimally suitable materials. Thus the material of the first belt part that is then functioning as intermediate layer can be optimized for guidance of the tension bearers, i.e. the stable and easy manufacturability of suitable grooves, the material of the second partial groove with respect to the transmission of the tensile forces from one drive sheave to the tension bearers, and/or the third belt part can be designed for best possible reversibility, in particular a low coefficient of friction, a high flexibility, and/or a high abrasion resistance.

Advantageously, the side of the second belt part that faces away from the first belt part can form a traction surface to interact with a drive sheave of the elevator system. For this purpose, this traction surface can have a coating and/or one or more V-ribs to interact with corresponding grooves of the drive sheave of the elevator system.

By means of such a coating it is possible on the one hand for a defined coefficient of friction that can be different from the coefficient of friction of the material of the second belt part to be made available for the frictional engagement with the drive sheave. It is equally possible for other surface characteristics, for example the abrasion resistance, to be influenced. It is thus possible for a second belt part that is overall rather softer and to this extent readily divertible to be provided with a thin hard coating that is resistant to abrasion.

To increase the press-on pressure on a drive sheave and thereby the tractive and driving capacity with the same radial force and thereby the same bearing load and belt tension, the traction surface can be provided with V-ribs. At the same time, such V-ribs guide the belt advantageously in crosswise direction on a drive sheave. The ribs preferably have a V-shaped cross section with a flank angle of 60° to 120°, the range from 80° to 100° being preferable. The flank angle is the angle that is present between the two side faces (flanks) of a V-shaped rib. This range has emerged as an ideal compromise between a high tractive capacity and the danger of the belt jamming in the traction sheave.

The side of the belt that faces away from the traction surface, thus for example a surface of the first or—if present—third belt part, can form a sliding surface to interact with a diverting element of the elevator system. Through corresponding choice of material and/or a coating of the sliding surface, the load on diversion can be reduced. In particular, the abrasion resistance and/or the coefficient of friction of the sliding surface can be set in targeted manner. Thus the sliding surface of a first or third belt part of polyamide, polyethylene, and/or polyester in a preferred embodiment has a coefficient of friction of maximum 0.35, preferably of maximum 0.3, and particularly preferably a coefficient of friction less than or equal to 0.25.

A belt for an elevator system that is manufactured by a method according to the present invention comprises a first belt part that has an arrangement of grooves, in particular in the lengthwise direction of the belt, a tension bearer in at least one groove of the groove arrangement, and a second belt part that is connected to the first belt part in such manner that the tension bearer is accommodated in the interior of the belt.

Such a belt is easy to manufacture, the positionally correct arrangement of the tension bearers within the belt being advantageously effected by the grooves. If the materials of the first and second and possibly present third belt part are different, it is thus possible in such a belt for example for the coefficient of friction, the abrasion resistance, the impact resistance, and/or similar characteristics of the individual belt parts and a traction and/or sliding surface formed by them to be predetermined. It is thus possible, for example, for the first and third belt parts for a material such as, for example, polyamide, polyester, or polyethylene with a low coefficient of friction of preferably maximum 0.3 to be selected. Such a belt, that, with its sliding surface formed from the first and third belt parts, partly or multiply wraps diverting elements such as, for example, diverting pulleys, generates on its diversion only low frictional forces which in particular has the effect that the lateral guidance of the belt on a diverting pulley causes fewer problems and the driving force required for the elevator system is reduced.

If advantageously not only the traction surface but also the sliding surface has one or more ribs, also when diverting over belt sheaves in which the belt touches the belt sheave with its sliding surface, the belt can be guided laterally which prevents the belt of such belt sheaves from running off at the sides.

The belt parts can have different colors, to ensure correct mounting of the belt. For this purpose, the traction and sliding surfaces, for example, can be differently colored or coated. The belt parts can equally well be composed of materials of different colors.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 a cross section of a belt according to an embodiment of the present invention;

FIG. 2 a cross section of the first belt part from FIG. 1 before arrangement of the tension bearers; and

FIG. 3 a cross section of an elevator system with a belt according to an embodiment of the present invention parallel to an elevator car front.

### DESCRIPTION OF THE PREFERRED EMBODIMENT

The U.S. provisional patent application Ser. No. 60/822,123 filed Aug. 11, 2006 is hereby incorporated herein by reference.

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

FIG. 2 shows a first belt part 13 made of polyamide. This has V-shaped grooves 13.1. Such a belt can be manufactured, for example, by means of extrusion, the grooves 13.1 being advantageously already formed in the molding process. To keep the flexural loading of the first belt part when being passed over belt sheaves as low as possible, the former has a maximum thickness of 2 mm or one third of the entire belt thickness.

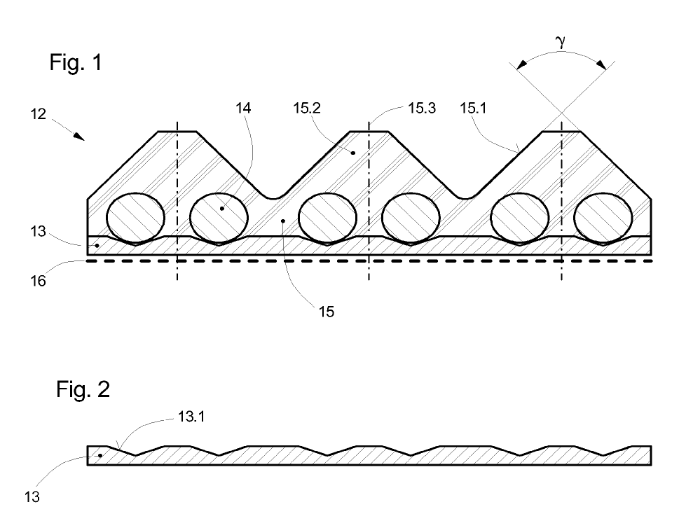

For the purpose of manufacturing a belt 12 according to an embodiment of the present invention, one tension bearer 14 is first arranged in each of the grooves 13.1 of the first belt part 13 shown in FIG. 2. In a manner that is not shown in more detail in FIG. 1, the tension bearer is embodied as a cord of wire rope or wire strands that are themselves constructed of individual steel wires that are individually laid together.

If, with the same first belt part as a platform, various belts with different tensile strengths should be manufactured, it is not necessary to arrange a tension bearer in each groove. Thus, for example, every second groove can be left free which, with the same first belt part, results in an elevator belt with essentially half of the tensile strength but greater flexibility. The ability to use identical first belt parts for different elevator belts advantageously reduces the costs for tools, inventories, etc.

With a light pretension, the tension bearers 14 are pressed from above into the V-shaped grooves 13.1, as a result of which the latter deform elastically and essentially take on the contour of the tension bearers. In a subsequent partial step of the manufacturing method that is not explained in further detail, the first belt part can be heated to such an extent that the thermoplastic plastic is plasticized again sufficiently for the grooves to adapt to the tension bearers under plastic deformation. Equally well in another embodiment of a manufacturing method according to the present invention, the tension bearers can be laid essentially free of tension in the grooves 13.1 and are arranged positionally correct relative to each other by the latter. “Laid” is to be understood as any manner or means of feeding the tension bearers.

Subsequently, a second belt part 15 of polyurethane is extruded onto the first belt part 13 with tension bearers 14 that are arranged in its grooves 13.1. The second belt part surrounds the still free surface of the tension bearers and at the same time bonds itself thermally to the first belt part 13 at its surface that faces the second belt part and is not covered by tension bearers. The adhesion between the second belt part 15 and the tension bearers 14 that are partially embedded therein is high enough to transfer the tension forces that arise in the elevator system from one drive sheave via the second belt part onto the tension bearers.

FIG. 1 shows the resulting belt 12 in cross section. On its side that faces away from the first belt part 13, the second belt part 15 has V-ribs 15.2 with a flank angle γ of 90°. These can be equally well embodied by machining of the second belt part or, preferably, by molding of the second belt part, for example by the polyurethane being inserted between the first belt part 13 and a molding belt of the extrusion system (not shown) positioned at the height of the second belt part, that has a correspondingly complementary V-rib profile. The belt usually contains a plurality of tension bearers 14, and the first belt part 13 has several grooves 13.1 that guide the tension bearers, the gaps between adjacent grooves and tension bearers respectively being executed in such manner that to each of the V-ribs 15.2 an equal number of tension bearers 14 can be assigned and the respective group of tension bearers that is assigned to a V-rib 15.2 is arranged symmetrically to the center axis 15.3 of this V-rib.

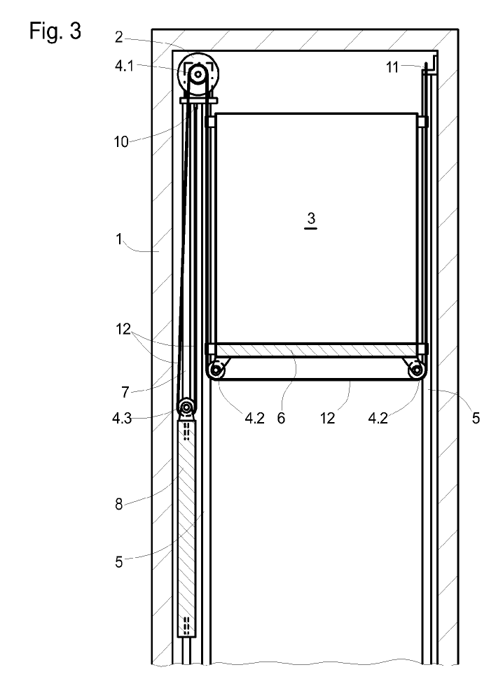

The first belt part 13 forms on its side (in FIG. 1, bottom) that faces away from the second belt part 15 a sliding surface that is provided for the purpose of diversion around a diverting element 4.2 (see FIG. 3). This sliding surface of polyamide has a low coefficient of friction as well as a high abrasion resistance. Advantageously, the frictional force that must be overcome to guide the belt on a diverting pulley is reduced, and thereby the lateral loading of the belt, for example by means of guide flanges of diverting pulleys and consequently also the traction power that is required. The service lives of the belt and of the diverting element are also lengthened.

The second belt part 15 forms on its side (in FIG. 1, top) that faces away from the first belt part 13 a traction surface 15.1 that is provided for the purpose of interacting with a drive sheave 4.1 (see FIG. 3). Should a different coefficient of friction be desired than that which is given by the polyurethane of the second belt part 15, the belt can have a coating on its traction surface. For example, the flanks of the V-ribs 15.2 that come into contact with a corresponding V-rib profile of the drive sheave can be coated with a thin polyamide foil 15.4. To simplify manufacture, it is equally possible for the entire traction surface to be coated with such a foil.

In a further embodiment of the present invention, the belt 12 contains a third belt part 16 of polyethylene that is arranged on the side of the first belt part 13 that faces away from the second belt part 15. In FIG. 1 this further embodiment, specifically the third belt part 16 that differentiates it from the previously described embodiment, is shown in dashed line.

FIG. 3 shows diagrammatically a cross section through an elevator system according to an embodiment of the present invention that is installed in an elevator hoistway 1. The elevator system comprises a drive 2 that is fixed in the elevator hoistway 1 with the drive sheave 4.1, an elevator car 3 that is guided on car guide rails 5 and under whose car floor 6 are mounted diverting pulleys in the form of the car suspension pulleys 4.2, a counterweight 8 that is guided on counterweight guide rails 7 with a further diverting pulley in the form of a counterweight suspension pulley 4.3, and the belt 12 for the elevator car 3 and the counterweight 8, that transfers the traction force from the drive sheave 4.1 of the drive unit 2 to the elevator car and the counterweight.

At one of its ends, the belt 12 is fastened below the drive sheave 4.1 to a first belt fastening point 10. From here, it extends downwards as far as the counterweight suspension pulley 4.3, wraps the latter, and from there extends to the drive sheave 4.1, wraps the latter and runs downwards along the counterweight side car wall, wraps by 90° each car suspension pulleys 4.2 that are mounted one on each side of the elevator car beneath the elevator car 3 and runs along the car wall that is away from the counterweight 8 upwards to a second belt fastening point 11.

The plane of the drive sheave 4.1 can be arranged at right angles to the counterweight side car wall and its vertical projection can lie outside the vertical projection of the elevator car 3. It is therefore preferable for the drive sheave 4.1 to have a smaller diameter so that the distance between the left-hand car wall and the opposite wall of the elevator hoistway 1 can be as small as possible. Furthermore, a smaller drive sheave diameter allows the use as the drive unit 2 of a gearless drive motor with relatively low traction torque.

The drive sheave 4.1 and the counterweight suspension pulley 4.3 are provided on their respective peripheries with grooves that correspond with the grooves 15.2 of the belt 12. Where the belt 12 wraps one of the belt sheaves 4.1 or 4.3, the ribs that are arranged on its traction surface lie in corresponding grooves of the belt sheave, whereby excellent guidance of the belt on these belt sheaves is assured. Furthermore, a wedge effect that arises between the grooves of the belt sheave 4.1 that serves as drive sheave and the grooves of the belt 12 can improve the tractive capacity.

In a further embodiment that is not shown, the sliding surface of the belt 12 and the car supporting pulleys 4.2 have corresponding V-ribs. Therefore, in contrast to conventional elevator systems, wrapping of the car suspension pulleys 4.2 below the elevator car 3 also provides a lateral guidance between the car suspension pulleys 4.2 and the belt 12, since the belt also has ribs on its side that faces the car suspension pulleys 4.2.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of manufacturing a belt for an elevator system comprising the steps of:
a. manufacturing a first belt part that has an arrangement of grooves that extend in a lengthwise direction of the first belt part;
b. arranging a tension bearer in at least one of the grooves; and
c. connecting a second belt part with the first belt part whereby the tension bearer is accommodated inside the belt.

2. The method according to claim 1 wherein the first belt part is manufactured from a thermoplastic plastic material.

3. The method according to claim 2 wherein the first belt part is manufactured from at least one of a polyamide (PA), a polypropylene (PP), a polyethylene (PE), a polycarbonate (PC), a polyvinylchloride (PVC), a polyblend, and a fabric of the thermoplastic plastic material.

4. The method according to claim 1 wherein the grooves are formed by one of thermal and mechanical deformation of the first belt part.

5. The method according to claim 1 the tension bearer is manufactured as a strand or a rope from one of individual steel wires and plastic fibers.

6. The method according to claim 1 wherein the second belt part is manufactured from an elastomer including one of a polyurethane (PU), a polychloroprene (CR), and a ethylene propylene diene rubber (EPDM).

7. The method according to claim 6 wherein the elastomer has a hardness in a range of 70 to 100 Shore (A).

8. The method according to claim 1 wherein the second belt part is joined to the first belt part by extrusion or adhesive bonding.

9. The method according to claim 1 including arranging on a side of the first belt part that faces away from the second belt part a third belt part that is made of a thermoplastic plastic including at least one of a polyamide (PA), a polypropylene (PP), a polyethylene (PE), a polycarbonate (PC), a polyvinylchloride (PVC), a polyblend, and a fabric of the thermoplastic plastic.

10. The method according to claim 1 wherein a side of the second belt part that faces away from the first belt part forms a traction surface for interacting with a drive sheave of the elevator system.

11. The method according to claim 10 wherein the traction surface has at least one V-rib for interacting with a corresponding groove of a drive sheave of the elevator system.

12. The method according to claim 11 wherein the belt includes a plurality of tension bearers, the first belt part contains an associated groove for guiding each of the tension bearers and distances between adjacent ones of the grooves and the tension bearers position an equal number of the tension bearers arranged symmetrically relative to a center axis of the at least one V-rib.

13. The method according to claim 10 wherein the traction surface has a coating.

14. The method according to claim 10 wherein a side of the belt that faces away from the traction surface forms a sliding surface for interacting with a diverting pulley of the elevator system.

15. A belt for an elevator system manufactured according to the method of claim 1 comprising:
the first belt part that has the arrangement of grooves extending in the lengthwise direction of the belt;
the tension bearer in the at least one groove; and
the second belt part that is connected to the first belt part wherein the tension bearer is accommodated inside the belt.

16. An elevator system with an elevator car, a drive, and a belt arrangement with at least one belt according to claim 15.
